(19) United States
(12) Patent Application Publication
(10) Pub. No.: US 2026/0341000 A1
(43) Pub. Date: Oct. 29, 2026

(54) ELECTRONIC DEVICE AND OPERATION METHOD FOR GENERATING UI OBJECT

(71) Applicant: SAMSUNG ELECTRONICS CO., LTD., Suwon-si (KR)

(72) Inventors: Eunhye JEE, Suwon-si (KR); Jeongseob KIM, Suwon-si (KR); Soora PARK, Suwon-si (KR); Wanje PARK, Suwon-si (KR); Hyungwoo SHIN, Suwon-si (KR); Jiwoo LEE, Suwon-si (KR)

(21) Appl. No.: 19/690,228

(22) Filed: May 28, 2026

Related U.S. Application Data
(63) Continuation of application No. PCT/KR2024/015076, filed on Oct. 4, 2024.

(30) Foreign Application Priority Data
Nov. 30, 2023 (KR) 10-2023-0171374
Jan. 18, 2024 (KR) 10-2024-0008175

(51) Int. Cl. G06V 10/774; G06T 7/90; G06V 10/422

(52) U.S. Cl. CPC G06V 10/774; G06T 7/90; G06V 10/422

(57) ABSTRACT

An electronic device may include a memory for storing instructions. The electronic device may include a processor for executing the instructions. The instructions, when executed by the processor, may cause the electronic device to acquire an image. The instructions, when executed by the processor, may cause the electronic device to obtain first feature information of an app for which a target UI object is to be generated. The instructions, when executed by the processor, may cause the electronic device to extract second feature information from the image. The instructions, when executed by the processor, may cause the electronic device to generate the target UI object related to the app on the basis of the first feature information and the second feature information.

### CROSS-REFERENCE TO RELATED APPLICATIONS

This application is a continuation application of International Application No. PCT/KR2024/015076, filed on Oct. 4, 2024, in the Korean Intellectual Property Receiving Office, and claiming priority to KR Application No. 10-2023-0171374 filed Nov. 30, 2023 and KR Application No. 10-2024-0008175 filed Jan. 18, 2024, the disclosures of which are all hereby incorporated by reference herein in their entireties.

### TECHNICAL FIELD

Certain example embodiments may relate to an electronic device for generating a user interface (UI) object and/or a method of operating the same.

### BACKGROUND

With changes in the times, more people seek to express their individuality externally. Accordingly, an electronic device, such as a smartphone, which is an essential item in daily life, is used as one way to express individuality. For example, people use images that represent their individuality well as backgrounds on electronic devices, such as smartphones. However, beyond that, some people customize and use user interface (UI) objects, such as an icon of an application (app) that is provided by default by an app provider.

The above description has been possessed or acquired by the inventor(s) in the course of conceiving the present disclosure and is not necessarily an art publicly known before the present application is filed.

### SUMMARY

An electronic device according to an example embodiment may include memory storing instructions. The electronic device may include a processor (comprising one or more processors), comprising processing circuitry, configured to execute the instructions. The instructions, when executed (individually and/or collectively) by the processor, may cause the electronic device to obtain an image. The instructions, when executed by the processor, may cause the electronic device to obtain first feature information of an application (app) to generate a target user interface (UI) object. The instructions, when executed by the processor, may cause the electronic device to extract second feature information from the image. The instructions, when executed by the processor, may cause the electronic device to generate the target UI object related to the app, based on the first feature information and the second feature information.

An electronic device according to an example embodiment may include memory storing instructions. The electronic device may include a processor (comprising one or more processors), comprising processing circuitry, configured to execute the instructions. The instructions, when executed (individually and/or collectively) by the processor, may cause the electronic device to obtain at least one first image. The instructions, when executed by the processor, may cause the electronic device to generate a second image using at least a portion of auxiliary information and information related to an app to generate at least one target UI object based on at least a portion of a feature of the at least one first image. The instructions, when executed by the processor, may cause the electronic device to generate the at least one target UI object related to execution of a function of the app based on the second image.

A method of operating an electronic device according to an example embodiment may include obtaining an image. The method may include obtaining first feature information of an app to generate a target UI object. The method may include extracting second feature information from the image. The method may include generating the target UI object related to the app, based on the first feature information and the second feature information.

A computer-readable non-transitory storage medium according to an example embodiment may store one or more programs including instructions executing the method of operating the electronic device.

A method of operating an electronic device according to an example embodiment may include obtaining an image. The method may include obtaining first feature information of an app to generate a target UI object. The method may include extracting second feature information from the image. The method may include generating the target UI object related to the app, based on the first feature information and the second feature information.

A non-transitory computer-readable storage medium according to an example embodiment may store one or more programs including instructions executing the method of operating the electronic device.

### BRIEF DESCRIPTION OF DRAWINGS

FIG. 1 is a block diagram illustrating an electronic device in a network environment according to various example embodiments.

FIG. 2 is a diagram illustrating generation of a target user interface (UI) object according to an example embodiment.

FIGS. 3 and 4 are diagrams illustrating examples of generating a target UI object according to an example embodiment.

FIG. 5 is a diagram illustrating generation of a target UI object when a plurality of users uses an electronic device according to an example embodiment.

FIGS. 6-9 are diagrams illustrating a generated target UI object according to an example embodiment.

FIG. 10 is a diagram illustrating sharing a generated target UI object according to an example embodiment.

FIG. 11 is a diagram illustrating a target UI object having a different personalization level according to an example embodiment.

FIG. 12 is a diagram illustrating a three-dimensional (3D) target UI object according to an example embodiment.

FIG. 13 is a diagram illustrating a case in which a UI object is a widget according to an example embodiment.

FIG. 14 is a flowchart illustrating a method of operating an electronic device according to an example embodiment.

FIG. 15 is a block diagram of a generative artificial intelligence system according to various example embodiments.

### DETAILED DESCRIPTION

Hereinafter, embodiments are described in detail with reference to the accompanying drawings. When describing the embodiments with reference to the accompanying drawings, like reference numerals refer to like elements and a repeated description related thereto is omitted.

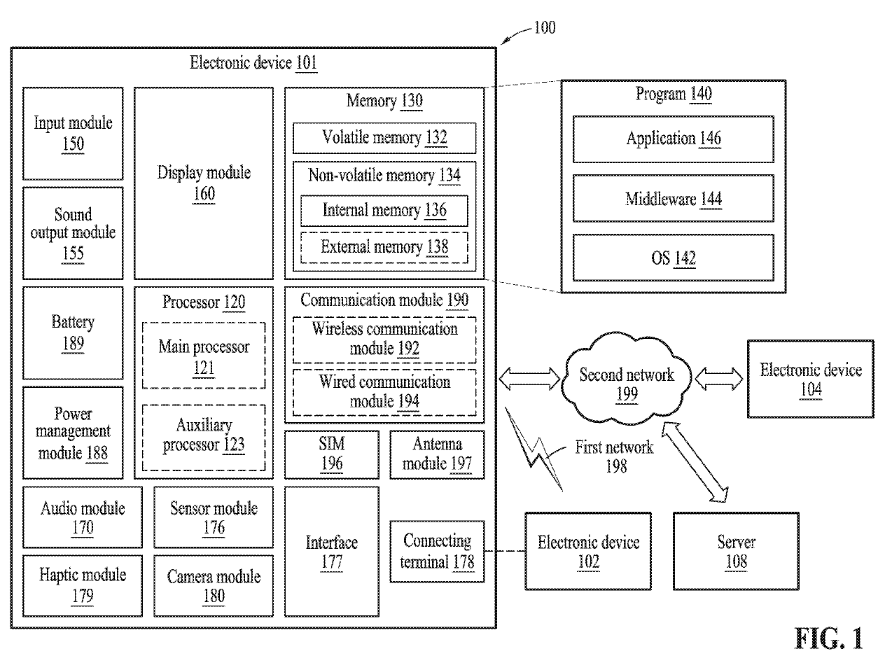

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added to the electronic device 101. In some embodiments, some of the components (e.g., the sensor module 176, the camera module 180, or the antenna module 197) may be integrated as a single component (e.g., the display module 160).

The processor 120 may execute, for example, software (e.g., a program 140) to control at least one other component (e.g., a hardware or software component) of the electronic device 101 connected, directly or indirectly, to the processor 120 and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented separately from the main processor 121 or as a part of the main processor 121.

The auxiliary processor 123 may control at least some of functions or states related to at least one (e.g., the display module 160, the sensor module 176, or the communication module 190) of the components of the electronic device 101, instead of the main processor 121 while the main processor 121 is in an inactive (e.g., sleep) state, or together with the main processor 121 while the main processor 121 is an active state (e.g., executing an application). According to an embodiment, the auxiliary processor 123 (e.g., an ISP or a CP) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The AI model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, or a combination of two or more thereof, but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output a sound signal to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, the hologram device, and the projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or an external electronic device (e.g., an electronic device 102) (e.g., a speaker or headphone) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly According to an embodiment, the interface 177 may include, for example, a high definition multimedia interface (HDMI), a universal serial bus (USB) interface, a secure digital (SD) card interface, or an audio interface.

The connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, ISPs, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more CPs that are operable independently from the processor 120 (e.g., the AP) and support a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multiple components (e.g., multiple chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a PCB, a RFIC disposed on a first surface (e.g., the bottom surface) of the PCB, or adjacent to the first surface and capable of supporting a designated high-frequency band (e.g., the mmWave band), and a plurality of antennas (e.g., array antennas) disposed on a second surface (e.g., the top or a side surface) of the PCB, or adjacent to the second surface and capable of transmitting or receiving signals of the designated high-frequency band.

At least some of the above-described components may be coupled, directly or indirectly, mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled, directly or indirectly, with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-Things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic device is not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as "A or B," "at least one of A and B," "at least one of A or B," "A, B, or C," "at least one of A, B, and C," and "at least one of A, B, or C," may include any one of, or all possible combinations of the items enumerated together in a corresponding one of the phrases. As used herein, such terms as "1st" and "2nd," or "first" and "second" may be used to simply distinguish a corresponding component from another, and does not limit the components in other aspects (e.g., importance or order). It is to be understood that if an element (e.g., a first element) is referred to, with or without the term "operatively" or "communicatively", as "coupled with," "coupled to," "connected with," or "connected to" another element (e.g., a second element), it means that the element may be coupled with the other element directly (e.g., wiredly), wirelessly, or via at least a third element(s).

As used in connection with various embodiments of the disclosure, the term "module" may include a unit implemented in hardware, software, or firmware, and may interchangeably be used with other terms, for example, "logic," "logic block," "part," or "circuitry". A module may be a single integral component, or a minimum unit or part thereof, adapted to perform one or more functions. For example, according to an embodiment, the module may be implemented in a form of an application-specific integrated circuit (ASIC). Thus, each “module” herein may comprise circuitry.

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include code generated by a compiler or code executable by an interpreter. The machine-readable storage medium may be provided in the form of a non-transitory storage medium. Wherein, the term "non-transitory" simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

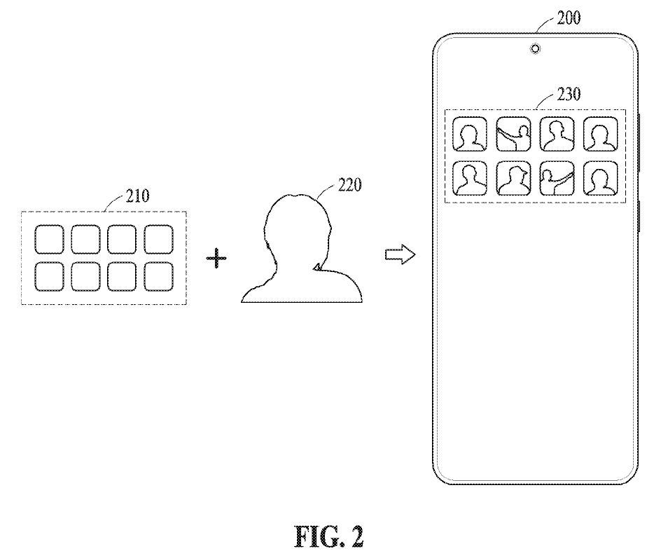

FIG. 2 is a diagram illustrating generation of a target user interface (UI) object according to an example embodiment.

Referring to FIG. 2, UI objects 210 of applications (hereinafter, also referred to as apps) and an electronic device 200 (e.g., the electronic device 101 of FIG. 1) that generates target UI objects 230 based on an object 220 are illustrated. For example, operations of the electronic device 200 described herein may be performed by executing instructions stored in a memory (e.g., the memory 130 of FIG. 1). The instructions may be stored in one memory or may be divided and stored in a plurality of memories. The instructions may be executed by one or more processors (e.g., the processor 120 of FIG. 1), and the instructions, when executed by the one or more processors, may cause the electronic device to perform operations described herein.

The target UI objects 230 may be personalized UI objects. In other words, the target UI objects 230 may be personalized UI objects as the object 220 includes a converted target object to indicate a property of an app. The target object may be generated based on a portion of the appearance of the object 220. The target UI objects 230 may include converted UI objects to indicate a property of the app and may include target objects related to execution of a function of the app. For example, when the app is an exercise app, the target UI object of the exercise app may be associated with a function (e.g., exercise management) of the app by including a running target object. The target UI objects 230 may be displayed on a display module instead of the UI objects 210.

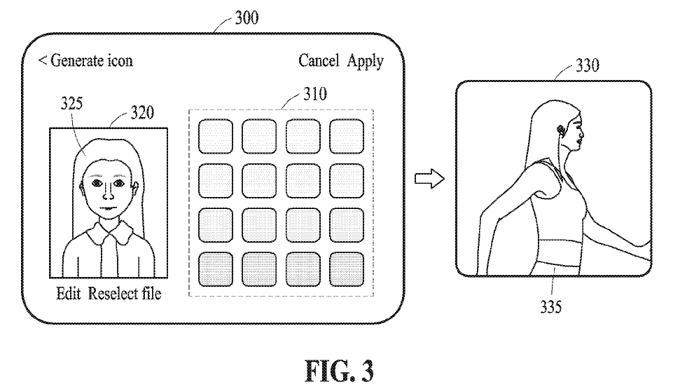

The electronic device 200 may obtain an image to generate the target UI objects 230. The image may include the object 220 to generate a target object. The object 220 may be a user of the electronic device 200, another person, an animal, a character, or an object. The electronic device 200 may begin generating the target UI objects 230 using various methods. A method of generating the target UI objects 230 is described with reference to FIGS. 3-5.

According to an embodiment, when a plurality of objects is included in the image, the electronic device 200 may receive a command from the user to generate the target UI objects 230 using one of the objects. According to an embodiment, when the plurality of objects is included in the image, the electronic device 200 may display candidate objects and may receive the object 220 selected by the user to generate the target UI objects 230 among the candidate objects.

According to an embodiment, the electronic device 200 may obtain a plurality of images including the object 220. The electronic device 200 may generate the target UI objects 230 using the object 220 included in the plurality of images.

The electronic device 200 may extract a feature portion from the image. The feature portion may include a first object included in the image, color information of the image, or a background of the image. The feature portion may be referred to as second feature information to be distinguished from feature information (in other words, first feature information) of an app described below.

The electronic device 200 may extract the object 220 from the image. The electronic device may extract the object 220 from the image using various methods. For example, the electronic device may extract the object 220 from the image using a deep learning-based object extraction model. According to an embodiment, the object 220 may be extracted by the electronic device 200 or may be extracted by a server (e.g., the server 108 of FIG. 1) that communicates with the electronic device 200. When the object 220 is extracted by the server, the electronic device may transmit an image to the server and in response thereto, may receive, from the server, the object 220 that is extracted from the image.

The electronic device 200 may obtain feature information of apps corresponding to the UI objects 210 to generate the target UI objects 230 together with the object 220. The feature information may include at least one of property information for describing the app, color information included in a UI object of the app, and information about an object included in the UI object of the app. The object 220 included in the image and the object included in the UI object of the app may be referred to as a first object and a second object, respectively, to distinguish from each other. The feature information of the app may also be referred to as first feature information to be distinguished from the feature portion (in other words, the second feature information) of the image.

The electronic device 200 may obtain the property information through an app market. The property information may be information that describes the app. The property information may include information that describes the app, such as a category of the app or a hashtag. However, this is an example, and in addition to the category of the app and the hashtag, other various pieces of information for describing the app may be included in the property information. According to an embodiment, the electronic device 200 may obtain the property information from metadata of the app. For example, the electronic device 200 may obtain the property information from manifest file information of an Android app.

The electronic device 200 may extract the color information from the UI object of the app. The color information may refer to a color of the UI object displayed on a display module (e.g., the display module 160 of FIG. 1) of the electronic device 200. The color information may include representative colors of the UI object and color effects (e.g., a gradient effect, a shadow effect, etc.). The electronic device 200 may obtain the color information using various methods.

The electronic device 200 may obtain information about the second object included in the UI object. The electronic device 200 may extract the second object from the UI object using various methods. For example, the electronic device may extract the second object from the UI object using a deep learning-based object extraction model. According to an embodiment, the deep learning-based object extraction model may be stored in the memory of the electronic device 200 or the server that communicates with the electronic device 200. Accordingly, the second object included in the UI object may be extracted by the electronic device 200 or the server that communicates with the electronic device 200. When the second object is extracted by the server, the electronic device may transmit the UI object to the server and in response thereto, may receive, from the server, the second object extracted from the UI object.

The electronic device 200 may determine whether the extracted second object is in the form of a human. When the extracted second object is in the form of a human, the electronic device 200 may identify which pose the extracted second object takes.

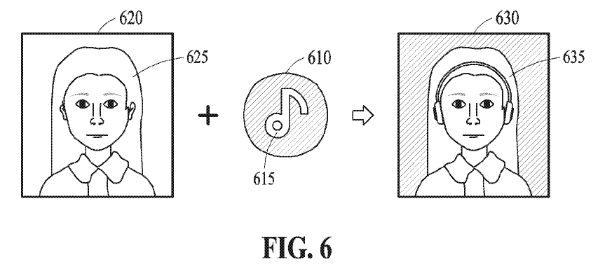

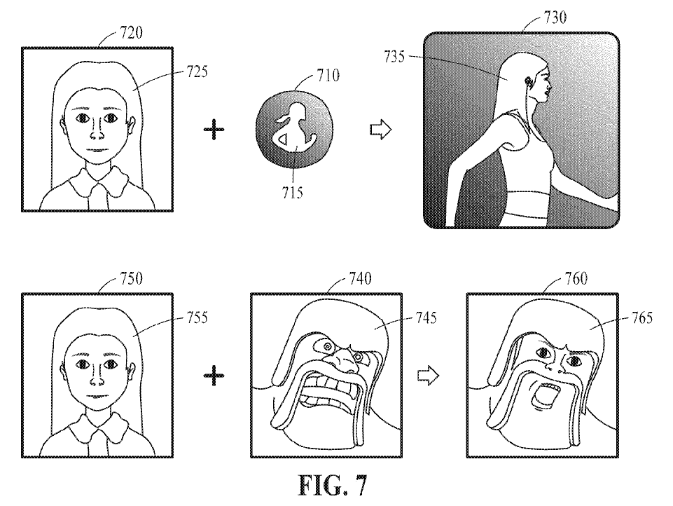

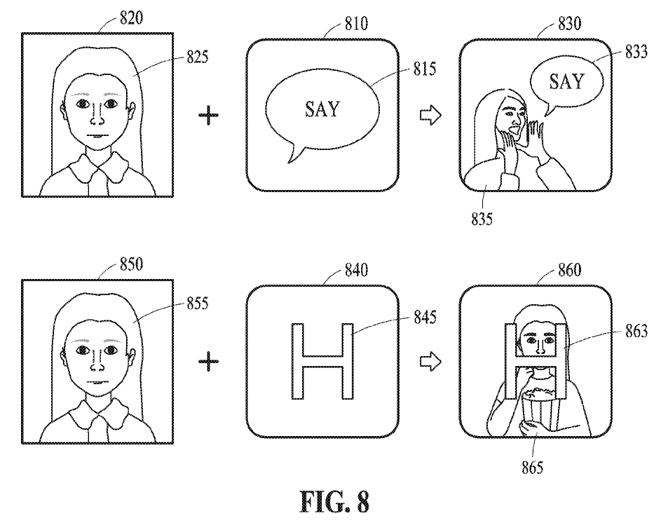

The electronic device 200 may generate a target UI object, based on the object 220 and the feature information of the app. The electronic device 200 may generate the target UI object, based on the feature of the object 220 and the feature information. The feature of the object 220 may be a face when the object 220 is a human. A method of generating a target UI object when the second object is in the form of a human and takes a specific pose is described with reference to FIG. 7. A method of generating a target UI object when the second object is not in the form of a human is further described with reference to FIGS. 6 and 8.

There may be various methods of generating a target UI object, based on the object 220 and the feature information. For example, a deep learning-based generative model may output the target UI object by receiving the object 220 and the feature information as inputs. For example, generative artificial intelligence (AI) may output the target UI object by receiving the object 220 and the feature information of the app as inputs. The generative AI may be a model that is trained by the electronic device to generate a target UI object, based on the object 220, feature information of the UI objects 210, and/or auxiliary information. The generative AI may be stored in the memory of the electronic device 200 or the server that communicates with the electronic device 200. Accordingly, via the generative AI, the target UI object may be generated by the electronic device 200 or the server that communicates with the electronic device 200. When the target UI object is generated by the server, the electronic device may transmit the object 220 and the feature information of the app to the server and in response thereto, may receive the target UI object from the server.

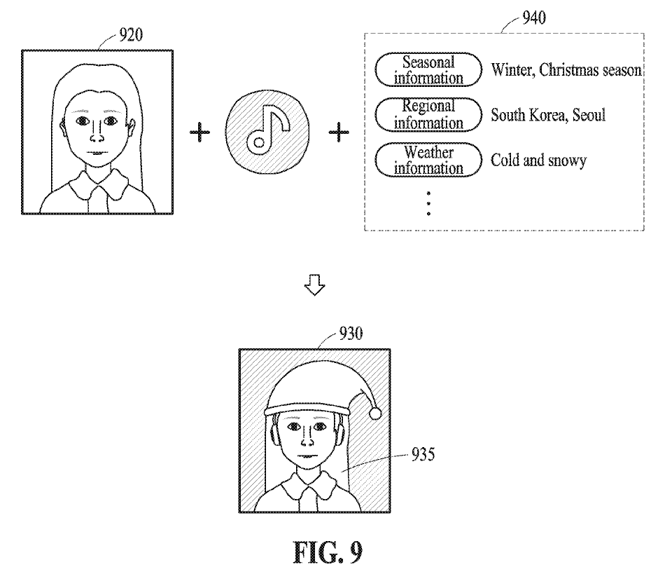

The electronic device 200 may generate the target UI object based on not only the object 220 and the feature information but also the auxiliary information. A method of generating a target UI object using the auxiliary information is described with reference to FIG. 9.

Herein, the UI objects may refer to interface elements for interacting between an app and a user, such as an icon of an app or a widget of the app. Accordingly, for ease of description, when the description is provided based on an assumption that the UI object is an icon of the app, the description of the icon of the app is applicable to the interface elements, such as the widget of the app. In addition, according to an embodiment, the UI objects may include interface elements, such as a wallpaper, a lock screen, and always on display (AOD).

In addition, the object of the image used for generating the target UI object in the present disclosure may be a person, an animal, a character, or an object. For ease of description, hereinafter, the object of the image is assumed to be a person, and for example, a method of generating a target UI object based on a human face is described. However, generation of a target UI object using a person is applicable to an animal, a character, and an object.

Hereinafter, a method of starting generating the target UI objects 230 is described.

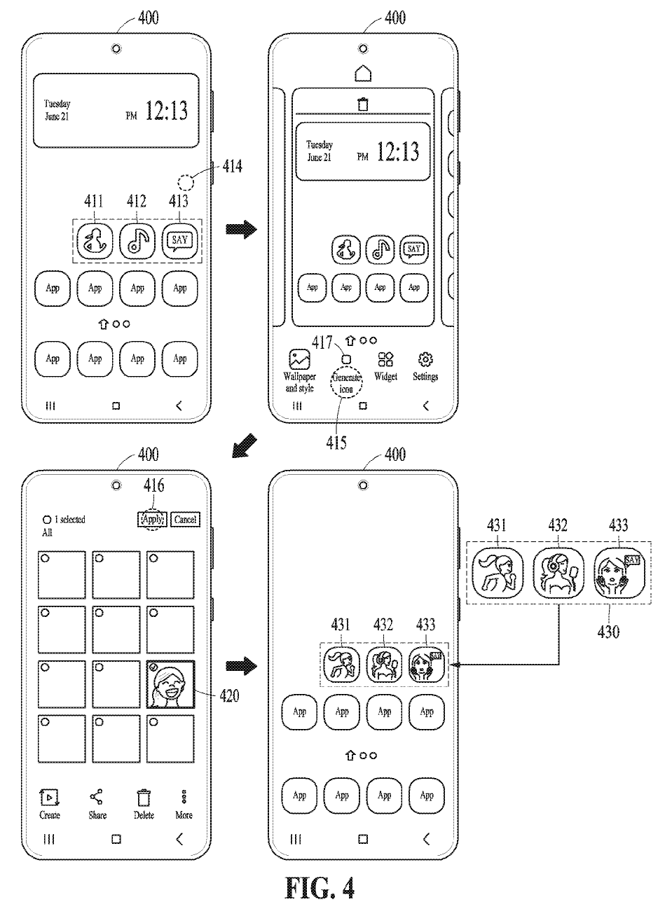

FIGS. 3 and 4 are diagrams illustrating examples of generating a target UI object according to an example embodiment.

Referring to FIG. 3, an electronic device 300 (e.g., the electronic device 101 of FIG. 1 or the electronic device 200 of FIG. 2) for generating a target icon 330 using an icon generation tool is illustrated. The electronic device 300 may provide the icon generation tool for generating the target icon 330. The icon generation tool may be a native app provided by a manufacturer of the electronic device 300 or a third-party app provided by an app market.

The electronic device 300 may receive a user's selection of an image to be used to generate the target icon 330. According to an embodiment, an image 320 may be an image that includes only a first object 325 (e.g., the object 220 of FIG. 2) to be used to generate the target icon 330. According to an embodiment, the image 320 may be an image cropped from an original image including a plurality of objects such that the cropped image only includes the first object 325.

The image 320 may be reselected. The image 320 may be reselected from images stored in the electronic device 300. The image 320 may be reselected to be an image that is captured directly via a camera (e.g., the camera module 180 of FIG. 1) included in the electronic device 300. According to an embodiment, the image 320 may be an image that is automatically selected based on information of an app installed in the electronic device 300. In other words, the image 320 may be a recommended image based on the information of the app installed in the electronic device 300. According to an embodiment, the image 320 may be a randomly and automatically selected image.

Icons 310 (e.g., the UI objects 210 of FIG. 2) may be a list of icons to be personalized based on the first object 325. According to an embodiment, the icons 310 may be icons of all apps stored in the electronic device 300. According to an embodiment, the icons 310 may be icons selected for personalization from all apps stored in the electronic device 300.

When the image 320 and the apps to be personalized are selected, the electronic device 300 may generate the target icon 330. Herein, only one target icon 330 is illustrated for ease of description; however, target icons corresponding to the icons 310 may be generated.

The target icon 330 may include a target object 335. The target object 335 may be generated based on the first object 325 and feature information (in other words, the first feature information) of an app corresponding to the target object 335. In addition, the target icon 330 may be generated based on the first object 325 and the feature information of the app.

According to an embodiment, the electronic device 300 may obtain a first image (e.g., the image 320). The electronic device 300 may generate a second image using information related to an app to generate the target UI object based on at least a portion of a feature of the first image and at least a portion of auxiliary information. In FIG. 3, the target UI object may be the target icon 330. The electronic device may generate the target UI object based on the second image. In this case, the image 320 may be referred to as the first image to be distinguished from the second image. In other words, the target object described herein may be an object included in the second image.

In this case, the electronic device may generate the target UI object using an AI model. The AI model may be a model that is trained to generate the second image using at least a portion of the auxiliary information and information related to an app to generate the target UI object based on at least a portion of the feature of the first image, and generate the target UI object based on the second image.

According to an embodiment, the target UI object may be obtained by contracting or cropping the second image. Alternatively, the target UI object may be obtained by converting the second image into a resolution that is optimized for the resolution supported by the display of the electronic device.

According to an embodiment, the electronic device may generate the target UI object in which an external FIGURE(e.g., a circle, a square, or a rounded square) of the UI object (e.g., an icon) and/or a theme applied to the electronic device is reflected.

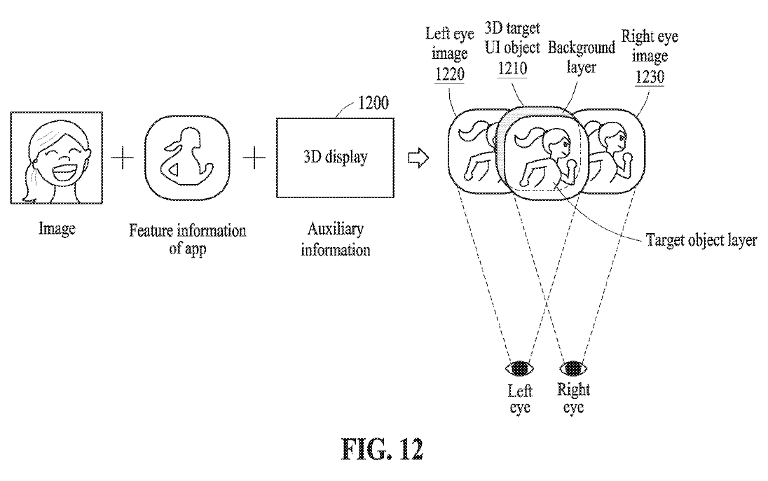

According to an embodiment, the electronic device may generate a three-dimensional (3D) target UI object depending on whether the electronic device supports a 3D effect. A method of generating a 3D target UI object is further described with reference to FIG. 12.

According to an embodiment, when the electronic device generates and stores the target UI object based on the second image, the electronic device may convert an extension (e.g., jpg, png, etc.) of the second image into an extension (e.g., ico) of the target UI object.

Referring to FIG. 4, a diagram illustrating a method of generating target icons 430 (e.g., the target icon 330 of FIG. 3) in a gallery app of an electronic device 400 (e.g., the electronic device 101 of FIG. 1, the electronic device 200 of FIG. 2, and the electronic device 300 of FIG. 3) is illustrated.

According to an embodiment, the electronic device 400 may enter a home screen editing mode to generate a personalized icon. The electronic device 400 may receive a user input 414 to enter the home screen editing mode. For example, the user input 414 may include an input (e.g., long press) to select a home screen (or a blank region of a screen). The home screen is assumed to include at least one UI object (e.g., a health app icon 411, a music app icon 412, a messenger app icon 413, and/or a widget).

According to an embodiment, the electronic device 400 may display a visual object 417 to generate an icon in a region of the home screen editing mode. When the electronic device 400 receives a user input 415 to select the visual object 417, the electronic device 400 may obtain a first image 420 (e.g., the image 320 of FIG. 3) to generate the icon. For example, the electronic device 400 may display an execution screen of the gallery app to obtain the first image 420. Alternatively, for example, the electronic device 400 may display a sub-menu including a gallery app execution item or a camera capture item, and when the electronic device 400 receives a user input to select the camera capture item, the electronic device 400 may obtain the first image 420 in real time by executing a camera app. In addition, according to an embodiment, when the electronic device 400 receives the user input 415 to select the visual object 417, the electronic device 400 may provide an icon generation tool of FIG. 3. Hereinafter, a case in which the execution screen of the gallery app is displayed is described.

In addition, according to an embodiment, when the electronic device receives the user input 415 to select the visual object 417, the electronic device may further display a screen (e.g., an app icon list and/or a widget list) to select at least one UI object to generate a personalized icon. The electronic device 400 may generate a personalized icon for the selected UI object (e.g., the health app icon 411, the music app icon 412, and the messenger app icon 413).

The electronic device 400 may display at least one image stored in the electronic device 400 in the gallery app. The electronic device 400 may select (or obtain) the first image 420 and may receive a user input (e.g., an apply button 416 selection input) to generate the icon.

When the electronic device 400 receives the user input, the electronic device 400 may generate at least one target UI object (e.g., a health app icon 431, a music app icon 432, a messenger app icon 433, and/or a widget) that is personalized based on at least a portion of a feature portion (in other words, the second feature information) of the first image 420. The feature portion of the first image 420 may include an object included in the first image 420, color information of the first image, or a background of the first image.

According to an embodiment, when there is an input motion that is longer than or equal to a threshold time with respect to the first image 420, the electronic device may display a pop-up window. The pop-up window may provide various options for the first image 420 that is selected. The pop-up window may provide a "generate as an icon" option for the first image 420. When the "generate as an icon" option is selected, the electronic device 400 may generate the target icons 430 using the first image 420.

According to an embodiment, when the "generate as an icon" option is selected, the electronic device may display the icon generation tool of FIG. 3 and may generate the target icon 430 via the icon generation tool. According to an embodiment, when the "generate as an icon" option is selected, after generating the target icon 430 in background, the electronic device 400 may display only the target icon 430 that is generated.

According to an embodiment, the electronic device 400 may receive selection of a plurality of images in the gallery app. The electronic device 400 may generate the target icon 430 using the plurality of selected images. The electronic device 400 may identify whether a common object is included in the plurality of images. The electronic device 400 may generate the target icon 430 using the common object.

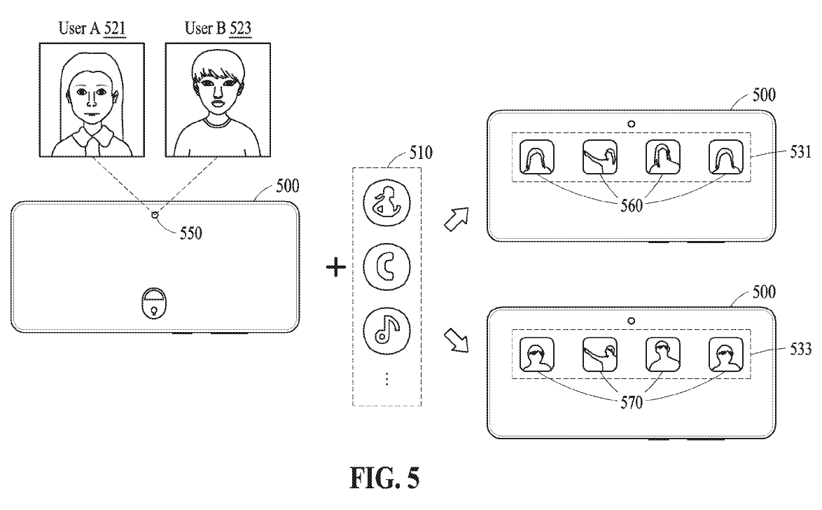

FIG. 5 is a diagram illustrating generation of a target UI object when a plurality of users uses an electronic device according to an example embodiment.

An electronic device 500 (e.g., the electronic device 101 of FIG. 1, the electronic device 200 of FIG. 2, the electronic device 300 of FIG. 3, and the electronic device 400 of FIG. 4) may be a device that a plurality of users (e.g., a user A and a user B) shares. The electronic device 500 may perform biometric recognition and may unlock the electronic device 500 based on a result of the biometric recognition. For example, the electronic device 500 may be unlocked by identifying a user through facial recognition.

The electronic device 500 may generate personalized target icons 531 and 533 using an image obtained for unlocking.

For example, when the user A attempts to unlock the electronic device 500, the electronic device 500 may obtain an image 521 (e.g., the image 320 of FIG. 3 and the image 420 of FIG. 4) of the user A in real time for unlocking. When an object included in the image 521 is identified as the user A, the electronic device may be unlocked. The electronic device 500 may generate the personalized target icons 531 with respect to icons 510 (e.g., the UI objects 210 of FIG. 2 and the icons 310 of FIG. 3) of apps stored in the electronic device 500 using the image 521 of the user A while unlocking. The electronic device 500 may display the personalized target icons 531 on a wallpaper after unlocking. The target icons 531 may include a target object generated based on the image 521 of the user A.

Similarly, when the user B attempts to unlock the electronic device, the electronic device may obtain an image 523 (e.g., the image 320 of FIG. 3 and the image 420 of FIG. 4) of the user B in real time for unlocking. In addition, the electronic device 500 may generate the personalized target icons 533 for the icons 510 of the apps stored in the electronic device 500 using the image 523. Since the target icons 531 are icons personalized for the user A, and the target icons 533 are icons personalized for the user B, the target icons 531 and the target icons 533 may be different from each other. In other words, the target icons 531 may include target objects 560 generated based on the user A, and the target icons 533 may include target objects 570 generated based on the user B.

According to an embodiment, when the electronic device 500 generates the personalized target icons 531 and 533, the electronic device 500 may store the generated target icons 531 and 533 and may fetch and display the generated target icons 531 and 533 on the wallpaper when the lock is unlocked. In other words, each time the lock is unlocked, the target icons 531 and 533 may not be newly generated, and target icons that are previously generated may be fetched. For example, when the target icons 531 for the user A are generated, the electronic device 500 may store the target icons 531. In addition, when the user A unlocks the electronic device 500 thereafter, the electronic device 500 may identify that the user who unlocks the electronic device 500 is the user A and may fetch and display the target icons 531 for the user A on a display module (e.g., the display module 160 of FIG. 1). In this case, since the target icons 531 are already generated and stored, the target icons 531 may be fetched. Accordingly, when the user who attempts to unlock the electronic device 500 is identified as the user A through not only facial recognition but also various biometric recognitions, the electronic device 500 may fetch and display the target icons 531 on the display module.

According to an embodiment, the electronic device 500 may store personalized target icons for some apps and may fetch and display the personalized target icons on the display module when the electronic device 500 is unlocked. In other words, for the other apps, target icons may be generated when unlocking. Among all target icons, some apps to be stored may be determined based on selection of the user. Alternatively, among all target icons, some apps to be stored may be determined to be apps that take a long generation time to generate the target icon. For example, the apps that take a long generation time to generate the target icon may be apps of which the generation times exceed a threshold time.

According to an embodiment, the electronic device 500 may compare an image of the user obtained when unlocking the electronic device 500 with an image of the user that is used previously when generating the target icons. When the image of the user obtained when unlocking the electronic device 500 is different from the image of the user that is used previously when generating the target icons, the electronic device 500 may regenerate the target icons using the image of the user obtained when unlocking the electronic device 500. For example, when a hairstyle of the user A in the image of the user A that is previously used is long hair, but the hairstyle of the user A in the image of the user A obtained when unlocking the electronic device 500 is short hair, the electronic device may regenerate the target icons 531 using the image of the user A obtained when unlocking the electronic device 500. A target object 560 included in the regenerated target icons 531 may have a short hair style.

According to an embodiment, when a threshold time has elapsed after the target icons are generated, the electronic device 500 may regenerate the target icons at the time of next unlock. For example, after the threshold time (e.g., one month) has elapsed after the target icons 531 for the user A are generated, the electronic device may regenerate the target icons 531 at the time of next unlock.

Hereinafter, a method of generating a target UI object is described.

FIGS. 6-9 are diagrams illustrating a generated target UI object according to an example embodiment.

Referring to FIG. 6, an image 620 (e.g., the image 320 of FIG. 3, the image 420 of FIG. 4, the image 521 of FIG. 5, and the image 523 of FIG. 5) and a target UI object 630 (e.g., the target icon 330 of FIG. 3 and the target icon 430 of FIG. 4) generated based on feature information (in other words, the first feature information) of an app are illustrated. A UI object 610 may be an icon for executing an app.

The image 620 may include a first object 625 (e.g., the object 220 of FIG. 2 and the first object 325 of FIG. 3) used for generating the target UI object 630. An electronic device (e.g., the electronic device 101 of FIG. 1, the electronic device 200 of FIG. 2, the electronic device 300 of FIG. 3, the electronic device 400 of FIG. 4, and the electronic device 500 of FIG. 5) may obtain the image 620 and the feature information of the app. Since the methods of obtaining the image 620 and extracting the first object 625 from the image 620 are described above with reference to FIGS. 2-5, the descriptions thereof are omitted. Since the method of obtaining the feature information of the app is described with reference to FIG. 2, the description thereof is omitted.

The feature information of the app may include at least one of property information for describing the app, color information included in the UI object 610, and information about a second object 615 included in the UI object 610 of the app. For example, referring to FIG. 6, the UI object 610 may be an icon for executing a music playback app.

For example, the electronic device may obtain information of which a category is music and hashtags are music and audio as the information for describing the music playback app. The electronic device may obtain information, such as a color forming the background of the app and a color forming the second object 615 included in the app as the color information of the music playback app. The electronic device may obtain the second object 615. Accordingly, the electronic device may obtain the second object 615 having a musical note shape. In addition, the electronic device may determine whether the second object 615 has a human shape. When the second object 615 has the human shape, a method of generating the target UI object 630 is further described with reference to FIG. 7.

The electronic device may generate the target UI object 630 based on the first object 625 and the feature information. Since the method of generating the target UI object 630 is described above with reference to FIG. 2, the description thereof is omitted.

The target UI object 630 may be a UI object personalized with the first object 625 while representing the characteristics of the app. For example, the target UI object 630 may represent the characteristics of the app (in other words, the music playback app) by including a target object 635 (e.g., the target object 335 of FIG. 3) in which the first object 625 listens to music using a headset.

According to an embodiment, the target UI object 630 may be generated using only the first object 625 and the property information of the app. Since the target UI object 630 needs to be personalized with the first object 625 while representing the characteristics of the app, the first object 625 and the property information of the app may be essential. Accordingly, the target UI object 630 that is generated based on only the first object 625 and the property information of the app may also be personalized with the first object 625 while representing the characteristics of the app. However, the target UI object 630 that is generated using not only the first object 625 and the property information of the app but also the color information and the information about the second object 615 may be consistent with the UI object 610, which is the original UI object of the app.

The target object 635 for listening to music may be generated based on the property information.

According to an embodiment, the electronic device may obtain a first image (e.g., the image 620). The electronic device may generate a second image using information related to an app to generate the target UI object 630 based on at least a portion of a feature of the first image and at least a portion of auxiliary information. At least a portion of the feature of the first image may be a feature portion (in other words, the second feature information) of the first image and may include at least a portion of the first object 625 included in the first image, the color information of the first image, or the background of the first image. In addition, the feature portion of the first image may include detailed information about the first object 625, such as clothing coordination information of the first object 625. The electronic device may generate the target UI object 630 based on the second image. In this case, the image 620 may be referred to as the first image to be distinguished from the second image. The target object 635 described herein may be an object included in the second image.

According to an embodiment, the electronic device may generate the target UI object 630 using an AI model. The AI model may be a model that is trained to generate the second image using at least a portion of the auxiliary information and information related to an app to generate the target UI object 630 based on at least a portion of the feature of the first image, and generate the target UI object based on the second image.

According to an embodiment, the target UI object 630 may be obtained by contracting or cropping the second image. Alternatively, the target UI object 630 may be obtained by converting the second image into a resolution that is optimized for the resolution supported by the display of the electronic device.

According to an embodiment, the electronic device may generate the target UI object 630 in which an external FIGURE(e.g., a circle, a square, or a rounded square) of the UI object 610 and/or a theme applied to the electronic device is reflected.

Since the methods of generating the second image and generating the target UI object based on the second image are identically applied to various embodiments of the present disclosure, the descriptions thereof are omitted.

Referring to FIG. 7, an example of generating the target UI object when the second object included in the UI object has a human shape is illustrated.

Referring to FIG. 7, an image 720 (e.g., the image 320 of FIG. 3, the image 420 of FIG. 4, the image 521 of FIG. 5, the image 523 of FIG. 5, and the image 620 of FIG. 6) and a target UI object 730 (e.g., the target icon 330 of FIG. 3, the target icon 430 of FIG. 4, and the target UI object 630 of FIG. 6) generated based on feature information (in other words, the first feature information) of an app are illustrated.

An electronic device (e.g., the electronic device 101 of FIG. 1, the electronic device 200 of FIG. 2, the electronic device 300 of FIG. 3, the electronic device 400 of FIG. 4, and the electronic device 500 of FIG. 5) may obtain the image 720 and the feature information of the app to generate the target UI object 730.

The feature information about the app may include at least one of property information of the app, color information included in the UI object 710 of the app, and information about a second object 715 (e.g., the second object 615 of FIG. 6) included in the UI object 710 of the app.

The UI object 710 (e.g., the UI object 610 of FIG. 6) may be an icon for executing a health-related app. For example, the electronic device may obtain information of which a category is health and fitness and hashtags are health, self-care, life coaching, diet, and exercise as information for describing the health-related app. The electronic device may obtain a color forming the background of the UI object 710 and a color forming the second object 715 included in the UI object 710 as the color information of the health-related app. For example, the electronic device may obtain green as the color forming the background of the UI object 710 and white as the color forming the second object 715. The electronic device may obtain a color effect of the UI object 710 as the color information of the health-related app. For example, the electronic device may obtain a gradient effect as the color effect of the app.

The electronic device may obtain the second object 715. The electronic device may determine whether the second object 715 has a human shape. The human shape may include a character or a silhouette in a human shape. For example, since the second object 715 indicates a portion of a running person, the electronic device may determine that the second object 715 has the human shape.

The electronic device may obtain the target UI object 730 using a first object 725 (e.g., the object 220 of FIG. 2 and the first object 625 of FIG. 6) and the feature information of the app. The target UI object 730 may reflect the first object 725 and the feature information of the app. For example, the background color of the target UI object 730 may be green, and the gradient effect may be applied thereto. A pose of a target object 735 (e.g., the target object 335 of FIG. 3 and the target object 635 of FIG. 6) included in the target UI object 730 may correspond to a portion of the external figure of the running person of the second object 715. A face of the target object 735 may partially correspond to the external figure of the object 725. In other words, the target object 735 may be generated by synthesizing a portion of the external figure of the first object 725 and a portion of the external figure of the second object 715 and may take a pose corresponding to a specific pose that the second object 715 takes.

According to an embodiment, the electronic device may refer to usage history information of the app rather than the external figure of the second object 715. The electronic device may generate the target object 735 using the usage history information of the app. For example, the electronic device may refer to the usage history information of the health-related app. The electronic device may generate a personalized target object that plays tennis based on a result (e.g., a favorite sport (e.g., tennis) of the user) of referring to the usage history of the health-related app.

In addition, referring to FIG. 7, an image 750 (e.g., the image 320 of FIG. 3, the image 420 of FIG. 4, the image 521 of FIG. 5, the image 523 of FIG. 5, and the image 620 of FIG. 6) and a target UI object 760 (e.g., the target icon 330 of FIG. 3, the target icon 430 of FIG. 4, and the target UI object 630 of FIG. 6) generated based on the feature information of the app are illustrated.

The electronic device may obtain the image 750 and the feature information of the app to generate the target UI object 760.

A UI object 740 (e.g., the UI object 610 of FIG. 1) may be an icon for executing a game app. For example, the electronic device may obtain information of which a category is game and strategy and hashtags are roll playing, adventure, and multi-play as information for describing the game app. The electronic device may obtain a color forming the background of the UI object 740 and a color forming a second object 745 (e.g., the second object 615 of FIG. 6) included in the UI object 740 as the color information of the game app. For example, the electronic device may obtain purple as the color forming the background and may obtain yellow and apricot as the colors forming the second object 745. The electronic device may obtain a color effect of the UI object 740 as the color information of the game app. For example, the electronic device may obtain no effect as the color effect of the game app.

The electronic device may obtain the second object 745. The electronic device may determine whether the second object 745 has a human shape. For example, since the second object 745 indicates a portion of a shouting person, the electronic device may determine that the second object 745 has the human shape.

The electronic device may obtain the target UI object 760 using a first object 755 (e.g., the object 220 of FIG. 2 and the first object 625 of FIG. 6) and the feature information of the app. The target UI object 760 may reflect the first object 755 and the feature information of the app. For example, the background color of the target UI object 760 may be purple, and there is no color effect. A pose of a target object 765 (e.g., the target object 335 of FIG. 3 and the target object 635 of FIG. 6) included in the target UI object 760 may correspond to a portion of the external figure of the shouting person corresponding to the second object 745. A face of the target object 765 may partially correspond to a portion of the external figure of the first object 755. In other words, the target object 765 may be generated by synthesizing a portion of the external figure of the first object 755 and a portion of the external figure of the second object 745 and may take a pose corresponding to a specific pose that the second object 745 takes.

Referring to FIG. 8, generation of a target UI object when the second object is not identified as a human shape is described.

Referring to FIG. 8, an image 820 (e.g., the image 320 of FIG. 3, the image 420 of FIG. 4, the image 521 of FIG. 5, the image 523 of FIG. 5, the image 620 of FIG. 6, the image 720 of FIG. 7, and the image 750 of FIG. 7) and a target UI object 830 (e.g., the target icon 330 of FIG. 3, the target icon 430 of FIG. 4, the target UI object 630 of FIG. 6, the target UI object 730 of FIG. 7, and the target UI object 760 of FIG. 7) generated based on feature information (in other words, the first feature information) of an app are illustrated.

An electronic device (e.g., the electronic device 101 of FIG. 1, the electronic device 200 of FIG. 2, the electronic device 300 of FIG. 3, the electronic device 400 of FIG. 4, and the electronic device 500 of FIG. 5) may obtain the image 820 and the feature information of the app to generate the target UI object 830.

The feature information about the app may include at least one of property information of the app, color information included in the UI object 810 of the app, and information about a second object 815 (e.g., the second object 615 of FIG. 6, the second object 715 of FIG. 7, and the second object 745 of FIG. 7) included in the UI object 810 of the app.

The UI object 810 (e.g., the UI object 610 of FIG. 6, the UI object 710 of FIG. 7, and the UI object 740 of FIG. 7) may be an icon for executing a messenger app. For example, the electronic device may obtain information of which a category is social networking and hashtags are chat, messenger, and communication as information for describing the messenger app. The electronic device may obtain a color forming the background of the UI object 810 and a color forming the second object 815 included in the UI object 810 as the color information of the messenger app. For example, the electronic device may obtain yellow as the color forming the background and may obtain brown as the color forming the second object 815. The electronic device may obtain a color effect of the UI object 810 as the color information of the messenger app. For example, the electronic device may obtain no effect as the color effect of the messenger app.

The electronic device may obtain the second object 815. The electronic device may determine whether the second object 815 has a human shape. For example, the electronic device may determine that the second object 815 does not have a human shape because the second object 815 is a speech bubble object and may determine that the second object 815 is a logo. The electronic device may determine that the second object 815 has a speech bubble shape and occupies 50% or more of the UI object 810.

The electronic device may obtain the target UI object 830 using a first object 825 (e.g., the object 220 of FIG. 2, the first object 625 of FIG. 6, the first object 725 of FIG. 7, and the first object 755 of FIG. 7) and the feature information of the app. The target UI object 830 may reflect the first object 825 and the feature information of the app. For example, the background color of the target UI object 830 may be yellow, and there is no color effect. A target object 835 (e.g., the target object 335 of FIG. 3, the target object 635 of FIG. 6, the target object 735 of FIG. 7, and the target object 765 of FIG. 7) included in the target UI object 830 may be generated based on property information and a portion of an external figure of the first object 825. In other words, the target object 835 may be an object representing the property information of the app using the portion of the external figure of the first object 825. For example, the target object 835 may be generated as an image of a person who delivers speech with their hands near their mouth to represent the property of the app, such as communication and chat. A face of the target object 835 may partially correspond to a portion of the external figure of the first object 825. In addition, the target UI object 830 may include not only the target object 835 but also the second object 815. A second object 833 of the target UI object 830 may have a different size or arrangement from the second object 815 of the UI object 810.

In addition, referring to FIG. 8, an image 850 (e.g., the image 320 of FIG. 3, the image 420 of FIG. 4, the image 521 of FIG. 5, the image 523 of FIG. 5, the image 620 of FIG. 6, the image 720 of FIG. 7, and the image 750 of FIG. 7) and a target UI object 860 (e.g., the target icon 330 of FIG. 3, the target icon 430 of FIG. 4, the target UI object 630 of FIG. 6, the target UI object 730 of FIG. 7, and the target UI object 760 of FIG. 7) generated based on feature information of an app are illustrated.

An electronic device (e.g., the electronic device 101 of FIG. 1, the electronic device 200 of FIG. 2, the electronic device 300 of FIG. 3, the electronic device 400 of FIG. 4, and the electronic device 500 of FIG. 5) may obtain the image 850 and the feature information of the app to generate the target UI object 860.

The feature information about the app may include at least one of property information of the app, color information included in the UI object 840 of the app, and information about a second object 845 (e.g., the second object 615 of FIG. 6, the second object 715 of FIG. 7, and the second object 745 of FIG. 7) included in the UI object 840 of the app.

The UI object 840 (e.g., the UI object 610 of FIG. 6, the UI object 710 of FIG. 7, and the UI object 740 of FIG. 7) may be an icon for executing a video streaming app. For example, the electronic device may obtain information of which a category is entertainment and hashtags are movie and drama as information for describing the video streaming app. The electronic device may obtain a color forming the background of the UI object 840 and a color forming the second object 845 included in the UI object 840 as the color information of the video streaming app. For example, the electronic device may obtain black as the color forming the background and may obtain red as the color forming the second object 845. The electronic device may obtain a color effect of the UI object 840 as the color information of the video streaming app. For example, the electronic device may obtain no effect as the color effect of the messenger app.

The electronic device may obtain the second object 845. The electronic device may determine whether the second object 845 has a human shape. For example, the electronic device may determine that the second object 845 does not have a human shape because the second object 845 has a large N-shape and may determine that the second object 845 is a logo.

The electronic device may obtain the target UI object 860 using a first object 855 (e.g., the object 220 of FIG. 2, the first object 625 of FIG. 6, the first object 725 of FIG. 7, and the first object 755 of FIG. 7) and the feature information of the app. The target UI object 860 may reflect the first object 855 and the feature information of the app. For example, the background color of the target UI object 860 may be black, and there is no color effect. A target object 865 (e.g., the target object 335 of FIG. 3, the target object 635 of FIG. 6, the target object 735 of FIG. 7, and the target object 765 of FIG. 7) included in the target UI object 860 may be generated based on property information and a portion of an external figure of the first object 855. In other words, the target object 865 may be an object representing the property information of the app using the portion of the external figure of the first object 855. For example, the target object 865 may be generated as an image of a person who holds popcorn and watches a video to represent the property of the app, such as movie and drama. In addition, the target UI object 860 may include not only the target object 865 but also the second object 845. A second object 863 of the target UI object 860 may have a different size or arrangement from the second object 845 of the UI object 840.

According to an embodiment, the electronic device may refer to usage history information of the app. The electronic device may generate the target objects 835 and 865 using the usage history information of the app. The usage history information of the app may be included in the auxiliary information. For example, the electronic device may refer to the usage history information of the video streaming app. The electronic device may generate the target object 865 related to a result (e.g., a video (e.g., movie) recently watched by the user) of referring to the usage history of the video streaming app. For example, the target object 865 may be related to a poster image of a movie recently watched by the user.

According to an embodiment, when the electronic device determines that the second objects 815 and 845 do not have human shapes, the electronic device may remove the second objects 815 and 845 when generating the target UI objects 830 and 860. For example, referring to FIG. 6, the target UI object 630 may not include the second object 615. However, in this case, the target UI objects 830 and 860 may include only the target objects 835 and 865 generated based on the property information of the app and portions of external figures of the first objects 825 and 855.

Referring to FIG. 9, a target UI object generated based on not only a first object and feature information of an app but also auxiliary information is illustrated.

Since methods, performed by an electronic device, of obtaining an image 920 (e.g., the image 320 of FIG. 3, the image 420 of FIG. 4, the image 521 of FIG. 5, the image 523 of FIG. 5, the image 620 of FIG. 6, the image 720 of FIG. 7, the image 750 of FIG. 7, the image 820 of FIG. 8, and the image 850 of FIG. 8) and feature information (in other words, the first feature information) of an app and generating a target UI object 930 (e.g., the target icon 330 of FIG. 3, the target icon 430 of FIG. 4, the target UI object 630 of FIG. 6, the target UI object 730 of FIG. 7, the target UI object 760 of FIG. 7, the target UI object 830 of FIG. 8, and the target UI object 860 of FIG. 8) based on the image and the feature information of the app are described above, the descriptions thereof are omitted.

The electronic device may further receive auxiliary information 940. The auxiliary information 940 may refer to information other than the feature information of the app. For example, the auxiliary information 940 may include a variety of information including seasonal information, regional information, and weather information. In addition, the auxiliary information 940 may include information received from another app, information received from an external server, and information received from a system of a terminal. The information received from the other app may include information received from an app linked to an app that attempts to generate the target UI object 930 and/or an app granted permission by the app that attempts to generate the target UI object 930. The information received from an external server may include information received from a server servicing an app that attempts to generate the UI object 930 and/or information about the app that attempts to generate the UI object 930 received from an app store. The information received from the system of the terminal may include regional information and/or carrier information obtained from SIM information. For example, the information received from the system of the terminal may include position information received from a GPS.

According to an embodiment, the auxiliary information 940 may be obtained from an app related to the app that attempts to generate the target UI object 930. The app related to the app that attempts to generate the target UI object 930 may be an app linked to the app that attempts to generate the target UI object 930. For example, when the app that attempts to generate the target UI object is an exercise app and the exercise app is linked to a weather app, weather information may be obtained from the weather app to generate the target UI object for the exercise app. In addition, the app related to the app that attempts to generate the target UI object 930 may be an app granted permission to access the app that attempts to generate the target UI object 930. For example, it may be assumed that the app that attempts to generate the target UI object 930 is a music playback app and a weather app and a map app have granted permission to access the music playback app. In this case, the target UI object 930 may be generated based on not only the image 920 and the feature information of the app but also seasonal information, regional information, and weather information. For example, a target object 935 (e.g., the target object 335 of FIG. 3, the target object 635 of FIG. 6, the target object 735 of FIG. 7, the target object 765 of FIG. 7, the target object 835 of FIG. 8, and the target object 865 of FIG. 8) in which winter and Christmas, which are the seasonal information, are reflected may be generated. In addition, the electronic device may provide a snow effect to the target UI object 930 by additionally reflecting the weather information (e.g., cold and snowy weather).

According to an embodiment, the auxiliary information 940 may be information received from the user via a prompt. For example, the electronic device may receive Christmas, which is the seasonal information, via the prompt. In response thereto, the electronic device may generate the target object 935 that reflects the seasonal information.

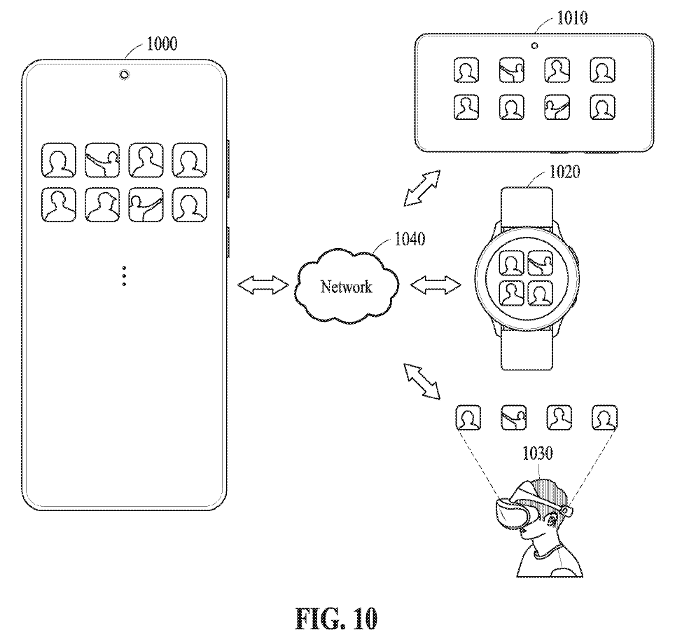

FIG. 10 is a diagram illustrating sharing a generated target UI object according to an example embodiment.

Referring to FIG. 10, a smartphone 1000, a tablet personal computer (PC) 1010, a smartwatch 1020, and head-mounted display (HMD) 1030, which are examples of an electronic device (e.g., the electronic device 101 of FIG. 1, the electronic device 200 of FIG. 2, the electronic device 300 of FIG. 3, the electronic device 400 of FIG. 4, and the electronic device 500 of FIG. 5), are illustrated.

The smartphone 1000, the tablet PC 1010, the smartwatch 1020, and the HMD 1030 may be electronic de vices of a same user. In other words, the smartphone 1000, the tablet PC 1010, the smartwatch 1020, and the HMD 1030 may be logged in with a same user account and may be synchronized via a network 1040 (e.g., the second network 199 of FIG. 1).

Accordingly, when one of the electronic devices illustrated in FIG. 10 generates target UI objects according to the operating methods described above with reference to FIGS. 2-9, the target UI objects may be shared with the other electronic devices.

For example, when the smartphone 1000 generates the target UI objects according to the operating methods described above with reference to FIGS. 2-9, the generated target UI objects may be shared with the tablet PC 1010, the smartwatch 1020, and the HMD 1030. As a result, the tablet PC 1010, the smartwatch 1020, and the HMD 1030 may display the target UI objects.

When the target UI object is modified in one of the electronic devices being synchronized, the modified target UI object may be shared with other electronic devices via the network 1040.

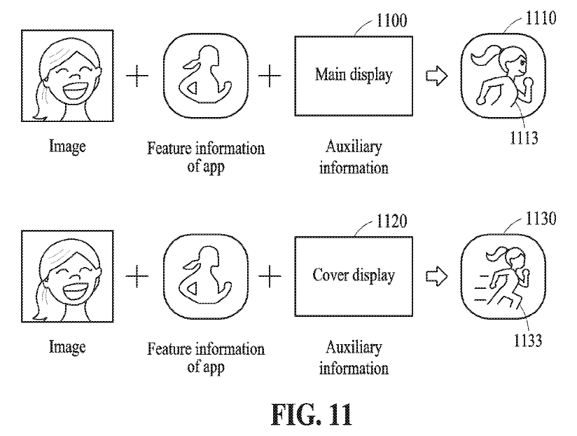

FIG. 11 is a diagram illustrating a target UI object having a different personalization level according to an example embodiment.

According to an embodiment, an electronic device (e.g., the electronic device 101 of FIG. 1, the electronic device 200 of FIG. 2, the electronic device 300 of FIG. 3, the electronic device 400 of FIG. 4, or the electronic device 500 of FIG. 5) may be a foldable electronic device.

The electronic device may generate a target UI object (e.g., the target icon 330 of FIG. 3, the target icon 430 of FIG. 4, the target UI object 630 of FIG. 6, the target UI object 730 of FIG. 7, the target UI object 760 of FIG. 7, the target UI object 830 of FIG. 8, the target UI object 860 of FIG. 8, and the target UI object 930 of FIG. 9) having a different personalization level depending on a position of a display. The position of the display may be included in the auxiliary information.

A main display 1100 may be a display that a user manipulates more than a cover display 1120. The cover display 1120 may be a display that is exposed to the outside when the foldable electronic device is folded, thereby allowing other people than the user to view.

Accordingly, the electronic device may determine a personalization level of a target UI object 1110 displayed on the main display 1100 to be higher than a personalization level of a target UI object 1130 displayed on the cover display 1120. As the personalization level increases, target objects 1113 and 1133 included in the target UI object 1110 and 1130 may be similar to objects of images used to generate the target UI objects 1110 and 1130. For example, when the target UI object 1110 includes a target object 1113 having a face of the user and running, the target UI object 1130 may include a target object 1133 having a simple running human shape. However, the face of the user may be various including not only an owner of the electronic device but also a celebrity that the owner of the electronic device likes.

According to an embodiment, the electronic device may differently set the personalization level depending on a position of a space to display the target UI object. The information about the position of the space to display the target UI object may be included in the auxiliary information. The electronic device may determine a personalization level of a target UI object displayed on a private space (e.g., an app drawer) to be higher than a personalization level of a target UI object displayed on a relatively public space (e.g., a home screen).

According to an embodiment, a target UI object having a different personalization level may be displayed depending on authentication. For example, in a financial app, a target UI object of an app in which user authentication is performed may include a target object having a higher personalization level than a target UI object of an app in which user authentication is not performed. In this case, authentication may be included in the auxiliary information.

FIG. 12 is a diagram illustrating a 3D target UI object according to an example embodiment.

According to an embodiment, an electronic device (e.g., the electronic device 101 of FIG. 1, the electronic device 200 of FIG. 2, the electronic device 300 of FIG. 3, the electronic device 400 of FIG. 4, or the electronic device 500 of FIG. 5) may be an HMD. When the electronic device is an HMD, the electronic device may include a lenticular lens structure and a parallax barrier structure. When the electronic device is an HMD, the electronic device may include a 3D display 1200 that provides a 3D effect. Whether the 3D display 1200 is included may be included in the auxiliary information. When the electronic device includes the 3D display 1200, the electronic device may generate a 3D target UI object 1210.

The electronic device may perceive a left eye image 1220 and a right eye image 1230 as a left eye and a right eye of a user, respectively. Accordingly, when the user views the 3D display 1200 from the front at a predetermined distance from the 3D display 1200, the user may perceive a 3D stereoscopic effect through binocular disparity.

The 3D target UI object 1210 may include multiple layers. For example, the 3D target UI object 1210 may include at least one of a background layer, a target object layer, an accessory layer (not illustrated), and/or an effect layer. When the user views the 3D display 1200 from the front (in other words, based on the Z-axis), the layers of the 3D target UI object 1210 may be spaced apart from each other, and when gaze information of the user stops at the 3D target UI object 1210 for a predetermined time period, one of the multiple layers may be focused or highlighted.

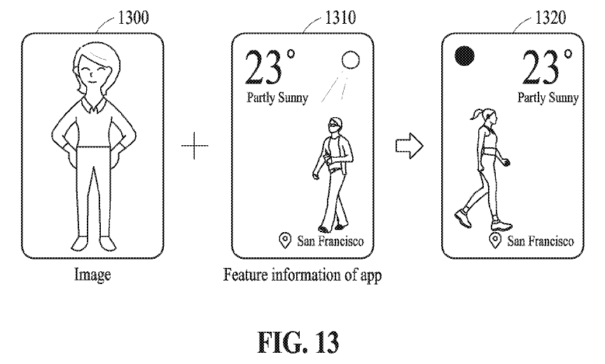

FIG. 13 is a diagram illustrating a case in which a UI object is a widget according to an example embodiment.

An electronic device (e.g., the electronic device 101 of FIG. 1, the electronic device 200 of FIG. 2, the electronic device 300 of FIG. 3, the electronic device 400 of FIG. 4, and the electronic device 500 of FIG. 5) may generate a target UI object 1320 (e.g., the target icon 330 of FIG. 3, the target icon 430 of FIG. 4, the target UI object 630 of FIG. 6, the target UI object 730 of FIG. 7, the target UI object 760 of FIG. 7, the target UI object 830 of FIG. 8, the target UI object 860 of FIG. 8, the target UI object 930 of FIG. 9, the target UI object 1110 of FIG. 11, and the target UI object 1130 of FIG. 11) that is personalized with respect to a widget 1310 in addition to an icon of an app.

The electronic device may generate a second image, based on a feature portion (in other words, the second feature information) of a first image 1300 (e.g., the image 320 of FIG. 3, the image 420 of FIG. 4, the image 521 of FIG. 5, the image 523 of FIG. 5, the image 620 of FIG. 6, the image 720 of FIG. 7, the image 750 of FIG. 7, the image 820 of FIG. 8, the image 850 of FIG. 8, and the image 920 of FIG. 9) and feature information (in other words, the first feature information) and may generate a target UI object 1320 based on the second image. In FIG. 13, the feature portion of the first image 1300 may include clothing coordination information of a user A. In FIG. 13, the feature information of the app may include weather widget information (e.g., clear weather information and/or position information) and/or auxiliary information (e.g., seasonal information and/or biometric information (e.g., body temperature) of the user A). Accordingly, the electronic device may generate the second image in which the user A walks on a clear day and may generate the target UI object 1320 that is personalized based on the second image.

In other words, the second image may be a personalized second image in which the user A of the first image 1300 is provided with clothing coordination that matches weather, season, and temperature information. For example, the second image may include the user A with warm clothing coordination based on cold weather and low body temperature of the user A, the user A with light clothing coordination based on clear weather and high body temperature of the user, and/or the user A with Christmas clothing coordination based on Christmas season information.

Certain example embodiments may apply not only the icon of the app and the widget 1310 but also various visual UI objects (e.g., the wallpaper, lock screen, AOD, and color skin, etc.).

According to an embodiment, the electronic device may update a visual UI object, such as an app icon, a widget, a wallpaper, a lock screen, and AOD, in the background. For example, when the electronic device obtains Christmas season information as the auxiliary information via a weather app and/or a calendar app, the electronic device may update existing target UI objects to target UI objects in which the Christmas information is reflected and may recommend the updated target UI objects to the user. The electronic device may allow the user to identify the updated target UI objects through various formats, such as a pop-up (or pop) window and/or a notification bar (or a no-ti-bar). For example, the electronic device may provide a pop-up window including guidance text (e.g., "Created an app icon for Christmas. Would you like to view?") to induce the user to view the updated target UI object. The electronic device may show the updated target UI objects according to a user input for selecting confirmation or may apply the updated target UI objects according to the selection of the user.

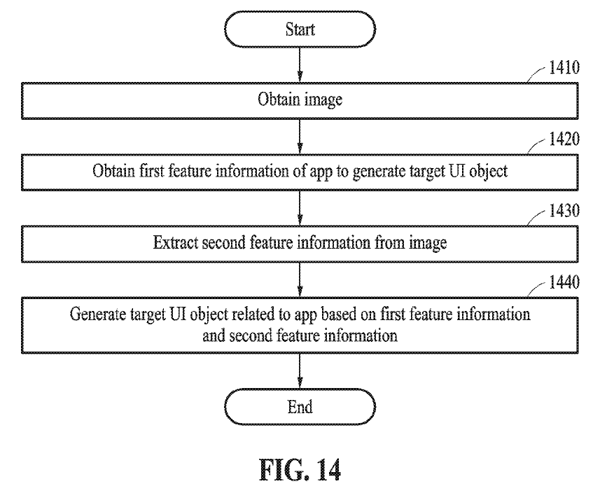

FIG. 14 is a flowchart illustrating a method of operating an electronic device according to an example embodiment.

Hereinafter, operations may be performed sequentially but not necessarily performed sequentially. For example, the order of operations may be changed, and at least two of the operations may be performed in parallel. The operations illustrated in FIG. 14 may be performed by at least one component of an electronic device (e.g., the electronic device 101 of FIG. 1, the electronic device 200 of FIG. 2, the electronic device 300 of FIG. 3, the electronic device 400 of FIG. 4, and the electronic device 500 of FIG. 5).

In operation 1410, the electronic device may obtain an image (e.g., the image 320 of FIG. 3, the image 420 of FIG. 4, the image 521 of FIG. 5, the image 523 of FIG. 5, the image 620 of FIG. 6, the image 720 of FIG. 7, the image 750 of FIG. 7, the image 820 of FIG. 8, the image 850 of FIG. 8, the image 920 of FIG. 9, and the first image 1300 of FIG. 13).

In operation 1420, the electronic device may obtain first feature information of an app to generate a target UI object (e.g., the target icon 330 of FIG. 3, the target icon 430 of FIG. 4, the target UI object 630 of FIG. 6, the target UI object 730 of FIG. 7, the target UI object 760 of FIG. 7, the target UI object 830 of FIG. 8, the target UI object 860 of FIG. 8, the target UI object 930 of FIG. 9, the target UI object 1110 of FIG. 11, and the target UI object 1130 of FIG. 11).

In operation 1430, the electronic device may extract second feature information from the image.

In operation 1440, the electronic device may generate a target UI object related to the app, based on the first feature information and the second feature information.

Since the descriptions provided above with reference to FIGS. 1-13 apply to each operation illustrated in FIG. 14, detailed descriptions thereof are omitted.

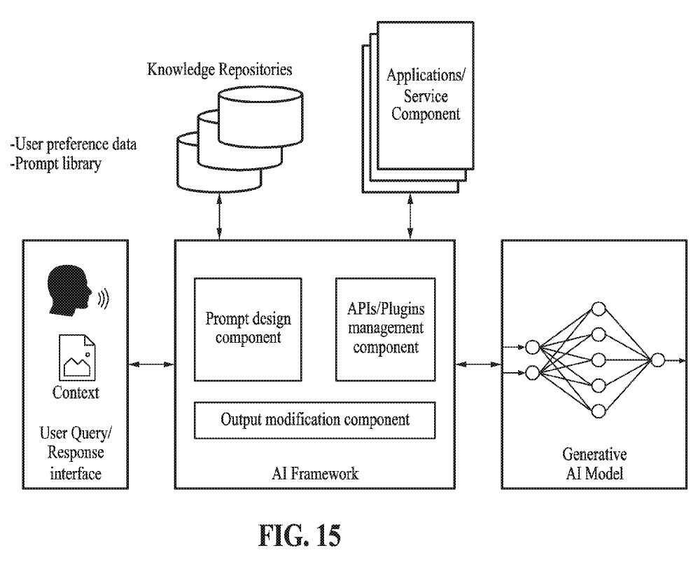

FIG. 15 is a block diagram of a generative artificial intelligence system according to various embodiments.

A user query/response interface may receive a user input. The user input may be in the form of a natural language, an image, and/or a video. In addition, when the user input is transmitted, context information may also be transmitted. The context information may include a variety of additional information at the time of the user input. For example, the context information may include information about an application currently used by the user or position information of the user. In addition, the user input may include a combination of the natural language, the image, sound, and the context information described above. In addition, the user input may include a non-natural language format, such as selecting a menu. The user query/response interface may output an outcome of a generative AI system to the user. The outcome may be provided in the form of natural language or specific content or may be provided as an action requested by the user. A user query interface may output a result of a generative AI system to the user. The outcome may be provided in the form of natural language or specific content or may be provided as an action requested by the user.

An AI framework may receive a user input and may coordinate and control each component required to perform intention of the user based on a user query.

The user input received via the user query/response interface may be transmitted to a prompt design component. The prompt design component may be used to generate a prompt suitable for inputting a user input to a large language model (LLM) or a large multimodal model (LMM). The prompt design component may be an AI component that uses a machine learning algorithm or a neural network to develop a better prompt over time. The prompt design component may generate a prompt by accessing a knowledge component (in other words, a knowledge repository) including user preference data, a prompt library, and a prompt example and may transmit the generated prompt to the LLM or LMM.

An application programming interface (API)/plugins management component may be configured to communicate with external information if additional information is requested when a user input is transmitted as an input to a generative model. The API/plugins management component may establish a channel for communicating with the outside of an AI interface via an API and may access various data sources via the established channel. In addition, when an action for performing a user input needs to be performed by an application or a server as a final result rather than an intermediate result, the API/plugins management component may request the action via the API. Information obtained from the outside may be used to generate a prompt in the prompt design component together with the user input and may be transmitted as an input to the generative model.

A refiner component (in other words, an output modification component) may fine-tune an outcome output by the generative model. For example, the refiner component may verify whether content generated via the LLM and/or LMM is irrelevant, is biased, or is harmful. In addition, the refiner component may determine how well the generated content matches a desired outcome of the user and, if an additional process is required, may perform the additional process. The refiner component may additionally form a hint to avoid an undesired output and may provide the hint to the user.

Typically, a generative AI model may refer to an AI neural network that generates new forms of data based on user input information. The generative AI model may include a model for generating an image and/or a model for generating text. Representative examples of the model for generating an image may be a generative adversarial network (GAN), a variational auto-encoder (VAE), and a diffusion-based generative model using the VAE and a transformer structure. The model for generating text may be a model that is trained to output a most statistically appropriate output value based on an input value, and representative examples thereof may be CHAT-GPT 3 and CHAT-GPT 4. In addition, an LMM for recognizing various types of data inputs, such as text, image, and voice and generating new data corresponding to the data inputs may be provided. A generative AI model may comprise one or more processors comprising processing circuitry.

According to an embodiment, the second feature information may include at least one of a first object (e.g., the object 220 of FIG. 2, the first object 625 of FIG. 6, the first object 725 of FIG. 7, the first object 755 of FIG. 7, the first object 825 of FIG. 8, and the first object 855 of FIG. 8), color information used in an image, and a background of the image.

According to an embodiment, the target UI object may be related to executing a function of the app and may be displayed on a display module instead of a UI object of the app.

According to an embodiment, the first feature information may include at least one of property information for describing the app, color information included in a UI object (e.g., the UI object 610 of FIG. 6, the UI object 710 of FIG. 7, the UI object 740 of FIG. 7, the UI object 810 of FIG. 8, and the UI object 840 of FIG. 8) of the app, and information about a second object (e.g., the second object 615 of FIG. 6, the second object 715 of FIG. 7, the second object 745 of FIG. 7, the second object 815 of FIG. 8, and the second object 845 of FIG. 8) included in the UI object of the app.

According to an embodiment, in generating the target UI object, the first feature information may include the information about the second object, and when the second object is identified as a human shape and takes a specific pose, the target UI object may be generated based on the first object and the second object of the second feature information.

According to an embodiment, the target UI object may be generated by synthesizing a portion of an external figure of the first object and a portion of an external figure of the second object and may include a target object (e.g., the target object 335 of FIG. 3, the target object 635 of FIG. 6, the target object 735 of FIG. 7, the target object 765 of FIG. 7, the target object 835 of FIG. 8, the target object 865 of FIG. 8, and the target object 935 of FIG. 9) that takes a pose corresponding to the specific pose.

According to an embodiment, in generating the target UI object, the first feature information may include the information about the second object, and when the second object is not identified as a human shape, the target UI object may be generated based on the property information and/or the second object.

According to an embodiment, the target UI object may include only a target object that is generated based on the property information and a portion of the external figure of the first object or may include the target object and the second object.

According to an embodiment, the operating method of the electronic device may further include obtaining auxiliary information (e.g., the auxiliary information 940 of FIG. 9) to generate the target UI object. According to an embodiment, in generating the target UI object, the target UI object may be generated based on the first object of the second feature portion, the first feature information, and the auxiliary information.

According to an embodiment, the auxiliary information may be information that is obtained from another app installed in the electronic device or is input from the user of the electronic device via the prompt.

According to an embodiment, the operating method of the electronic device may further include sharing the target UI object with one or more electronic devices of the user that are synchronized with the electronic device.

According to an embodiment, a non-transitory computer-readable storage medium may store one or more programs including instructions that execute one of the operating methods described above.

According to an embodiment, the electronic device may include a memory (e.g., the memory 130 of FIG. 1) storing instructions. The electronic device may include a processor (e.g., the processor 120 of FIG. 1, comprising one or more processors comprising processing circuitry) for executing instructions. The instructions, when executed by the processor, may cause the electronic device to obtain an image. The instructions, when executed by the processor, may cause the electronic device to obtain first feature information of an app to generate a target UI object. The instructions, when executed by the processor, may cause the electronic device to extract second feature information from an image. The instructions, when executed by the processor, may cause the electronic device to generate a target UI object related to the app based on the first feature information and the second feature information.

According to an embodiment, the second feature information may include at least one of a first object, color information used in the image, and a background of the image.

According to an embodiment, the target UI object may be related to executing a function of the app and may be displayed on a display module instead of a UI object of the app.

According to an embodiment, the first feature information may include at least one of property information for describing the app, color information included in a UI object of the app, and information about a second object included in the UI object of the app.

According to an embodiment, the instructions, when executed by the processor, may cause the electronic device to allow the first feature information to include the information about the second object, and when the second object is identified as a human shape and takes a specific pose, generate the target UI object based on the first object and the second object of the second feature information.

According to an embodiment, the target UI object may be generated by synthesizing a portion of the external figure of the first object and a portion of the external figure of the second object and may include a target object that takes a pose corresponding to the specific pose.

According to an embodiment, the instructions, when executed by the processor, may cause the electronic device to allow the first feature information to include the information about the second object, and when the second object is not identified as a human shape, generate the target UI object based on the property information and/or the second object.

According to an embodiment, the target UI object may include only a target object that is generated based on the property information and a portion of the external figure of the first object or may include the target object and the second object.

According to an embodiment, the instructions, when executed by the processor, may cause the electronic device to obtain the auxiliary information about the app. The instructions, when executed by the processor, may cause the electronic device to generate the target UI object based on at least a portion of the first object, the first feature information, and the auxiliary information.

According to an embodiment, the auxiliary information may be information that is obtained from apps related to the app or is input from the user of the electronic device via a prompt.

According to an embodiment, the instructions, when executed by the processor, may cause the electronic device to share the target UI object with one or more electronic devices of the user that are synchronized with the electronic device.

According to an embodiment, the electronic device may include memory storing instructions. The electronic device may include a processor (comprising one or more processors, with processing circuitry) executing instructions. The instructions, when executed by the processor, may cause the electronic device to obtain at least one first image. The instructions, when executed by the processor, may cause the electronic device to generate a second image using at least a portion of auxiliary information and information about an app to generate at least one target UI object based on at least a portion of a feature of at least one first image. The instructions, when executed by the processor, may cause the electronic device to generate at least one target UI object related to execution of a function of the app, based on the second image.

According to an embodiment, the instructions, when executed by the processor, may cause the electronic device to generate at least one target UI object using an AI model. The AI model may be a model that is trained to generate the second image using at least a portion of the auxiliary information and the information related to the app to generate at least one target UI object based on at least a portion of the feature of the first image, and is trained to generate at least one target UI object based on the second image.

According to an embodiment, the operating method of the electronic device may include obtaining at least one first image. The operating method of the electronic device may include generating the second image using at least a portion of the auxiliary information and the information about the app to generate at least one target UI object based on at least a portion of the feature of at least one first image. The operating method of the electronic device may include generating at least one target UI object related to execution of a function of the app based on the second image.

According to an embodiment, the instructions, when executed by the processor, may cause the electronic device to obtain a first image. The instructions, when executed by the processor, may cause the electronic device to generate a first prompt to generate a second image using an AI algorithm based on the first image. The instructions, when executed by the processor, may cause the electronic device to generate a second prompt in which at least a portion of the first prompt is modified using at least a portion of information related to a first application installed in the electronic device and first auxiliary information obtained using the electronic device. The instructions, when executed by the processor, may cause the electronic device to generate the second image via the AI algorithm based on the second prompt. The instructions, when executed by the processor, may cause the electronic device to generate at least one UI object related to execution of a function of the application using at least a portion of the second image.

According to an embodiment, the operating method of the electronic device may include obtaining the first image. The operating method of the electronic device may include generating a first prompt to generate the second image using an AI algorithm based on the first image. The operating method of the electronic device may include generating a second prompt in which at least a portion of the first prompt is modified using at least a portion of information related to a first application installed in the electronic device and first auxiliary information obtained using the electronic device. The operating method of the electronic device may include generating the second image via the AI algorithm based on the second prompt. The operating method of the electronic device may include generating at least one UI object related to execution of a function of the application using at least a portion of the second image.

The embodiments of the present disclosure disclosed in the specification and the drawings are merely presented to easily describe technical contents of various embodiments of the present disclosure and help the understanding of them and are not intended to limit the various embodiments. Therefore, all changes or modifications derived from the technical idea of the various embodiments of the present disclosure as well as the various embodiments disclosed herein should be construed to fall within the various embodiments.

1. An electronic device comprising:
memory storing instructions; and
a processor, comprising processing circuitry, configured to execute the instructions,
wherein the instructions, when executed by the processor, cause the electronic device to:
obtain an image, obtain first feature information of an application (app) to generate a target user interface (UI) object, extract second feature information from the image, and generate the target UI object related to the app, based on the first feature information and the second feature information.

2. The electronic device of claim 1,
wherein the second feature information comprises at least one of a first object, color information used in the image, and a background of the image.

3. The electronic device of claim 1,
wherein the target UI object is related to execution of a function of the app and is configured to be displayed on a display module instead of a UI object of the app.

4. The electronic device of claim 1,
wherein the first feature information comprises at least one of property information for describing the app, color information comprised in the UI object of the app, and information about a second objectcomprised in the UI object of the app.

5. The electronic device of claim 1,
wherein the processor comprises one or more processors, and the instructions, when executed by the processor, cause the electronic device to:
when the first feature information comprises the information about the second object and the second object is identified as a human shape and takes a specific pose, generate the target UI object based on a first object and the second object of the second feature information.

6. The electronic device of claim 1,
wherein the target UI object is generated by synthesizing a portion of an external figure of the first object and a portion of an external figure of the second object and comprises a target object that takes a pose corresponding to the specific pose.

7. The electronic device of claim 1,
wherein the processor comprises one or more processors, and the instructions, when executed by the processor, cause the electronic device to:
when the first feature information comprises the information about the second object and the second object is not identified as a human shape, generate the target UI object based on the property information and/or the second object.

8. The electronic device of claim 1,
wherein the target UI object comprises only the target object that is generated based on the property information or the portion of the external figure of the first object or comprises the target object and the second object.

9. The electronic device of claim 1,
wherein the processor comprises one or more processors, and the instructions, when executed by the processor, cause the electronic device to:
obtain auxiliary information for generating the target UI object and generate the target UI object based on at least a portion of the first object of the second feature information, the first feature information, and the auxiliary information.

10. The electronic device of claim 1,
wherein the auxiliary information is information that is obtained from other apps installed in the electronic device and/or is input by a user of the electronic device via a prompt.

11. The electronic device of claim 1,
wherein the processor comprises one or more processors, and the instructions, when executed by the processor, cause the electronic device to:
share the target UI object with one or more electronic devices of the user that are synchronized with the electronic device.

12. An electronic device comprising:
memory storing instructions; and
a processor, comprising processing circuitry, configured to execute the instructions,
wherein the instructions, when executed by the processor, cause the electronic device to:
obtain at least one first image, generate a second image using at least a portion of auxiliary information and information related to an application (app) to generate at least one target user interface (UI) object based on at least a portion of a feature of the at least one first image, and generate the at least one target UI object related to execution of a function of the app based on the second image.

13. The electronic device of claim 12,
wherein the processor comprises one or more processors, and the instructions, when executed by the processor, cause the electronic device to:
generate the at least one target UI object using an artificial intelligence model,
wherein the artificial intelligence model is a model that is trained to generate the second image using at least a portion of the auxiliary information and the information related to the app to generate the at least one target UI object based on at least a portion of a feature of the at least one first image and is trained to generate the at least one target UI object based on the second image.

14. A method of operating an electronic device, the method comprising:
obtaining an image;
obtaining first feature information of an application (app) to generate a target user interface (UI) object;
extracting second feature information from the image; and
generating the target UI object related to the app, based on the first feature information and the second feature information.

15. The method of claim 14,
wherein the second feature information comprises at least one of a first object, color information used in the image, and a background of the image.

16. The method of claim 14,
wherein the target UI object is related to execution of a function of the app and is configured to be displayed on a display module instead of a UI object of the app.

17. The method of claim 14,
wherein the first feature information comprises at least one of property information for describing the app, color information comprised in the UI object of the app, and information about a second objectcomprised in the UI object of the app.

18. The method of claim 14,
wherein generating the target UI object comprising:
when the first feature information comprises the information about the second object and the second object is identified as a human shape and takes a specific pose, generating the target UI object based on a first object and the second object of the second feature information.

19. The method of claim 14,
wherein the target UI object is generated by synthesizing a portion of an external figure of the first object and a portion of an external figure of the second object and comprises a target object that takes a pose corresponding to the specific pose.

20. The method of claim 14,
wherein generating the target UI object comprising:
when the first feature information comprises the information about the second object and the second object is not identified as a human shape, generating the target UI object based on the property information and/or the second object.
